(19) United States
(12) Patent Application Publication
(10) Pub. No.: US 2011/0066406 A1
(43) Pub. Date: Mar. 17, 2011

(54) Method for Generating Real-Time Haptic Response Information for a Haptic Simulating Device

(75) Inventors: Ming-Dar Tsai, Taipei City (TW); Ming-Shium Hsieh, Taipei City (TW)

(73) Assignees: CHUNG YUAN CHRISTIAN UNIVERSITY, Chung Li (TW); TAIPEI MEDICAL UNIVERSITY, Taipei City (TW)

(21) Appl. No.: 12/848,578

(22) Filed: Aug. 2, 2010

Related U.S. Application Data
(63) Continuation-in-part of application No. 12/559,607, filed on Sep. 15, 2009.

(30) Foreign Application Priority Data
Jan. 15, 2010 (TW) 099101062

(51) Int. Cl. G06F 17/50; G06F 17/10; H04B 3/36

(52) U.S. Cl. 703/1; 340/407.2; 703/2

(57) ABSTRACT

A method is provided for generating real-time haptic response information for a haptic simulating device during a surgery simulation performed by a virtual tool on an object volume that includes tissue voxels, null voxels, and object boundary points. The method includes: (a) receiving a select input of a selected virtual tool type; (b) obtaining tool boundary points of the virtual tool; (c) obtaining a current reference position of the virtual tool; (d) determining a current tool subvolume; and (e) when the current tool subvolume has at least one tissue voxel, (e-1) determining positions of the tool boundary points within the subvolume, (e-2) updating labels of the voxels within the subvolume and replacing an original set of the object boundary points within the subvolume with a new set of the object boundary points, (e-3) determining force-contributing ones of the tool boundary points, and (e-4) providing force information of a force to be generated by the haptic simulating device.

### CROSS-REFERENCE TO RELATED APPLICATION

This application claims priority of Taiwanese Application No. 099101062, filed on Jan. 15, 2010.

This application is also a continuation-in-part (CIP) of U.S. patent application Ser. No. 12/559,607, entitled “METHOD FOR GENERATING REAL-TIME HAPTIC RESPONSE INFORMATION FOR A HAPTIC SIMULATING DEVICE”, filed on Sep. 15, 2009.

### BACKGROUND OF THE INVENTION

1. Field of the Invention

The invention relates to a haptic response simulation method, more particularly to a method for generating real-time haptic response information for a haptic simulating device during a three-dimensional surgery simulation.

2. Description of the Related Art

Common surgical tools for spine surgeries have various shapes, including basic shapes, such as spherical (e.g., round fluted burr, round diamond burr, drum burr), ellipsoidal, cylindrical (e.g., heliocoidal rasp, diamond disc, straight router), frusto-conical, conical, and paraboloid, and combinations of these basic shapes (e.g., Acorn tool, which is composed of a cylindrical shape and a conical shape, Neuro tool, which is composed of a cylindrical shape and a semi-ellipsoid shape, Barrel tool, which is composed of a cylindrical shape and a semi-spherical shape), etc. One constraint of conventional surgery simulation systems is that all surgery simulations can only be done by virtual tools of the spherical burr type.

Another constraint of conventional surgery simulation systems is that the computations are very complicated and time consuming, thereby adversely affecting the resulting haptic responses, which should theoretically be in real-time.

### SUMMARY OF THE INVENTION

Therefore, the object of the present invention is to provide a method for generating real-time haptic response information for a haptic simulating device that can represent various virtual tool types and that can reduce computation time.

According to this invention, there is provided a method for generating real-time haptic response information for a haptic simulating device during a surgery simulation performed on an object volume by a virtual tool that is associated with the haptic simulating device. The object volume is defined in a three-dimensional object coordinate system, and includes a plurality of uniformly-spaced-apart voxels. Each of the voxels is labeled as one of a tissue voxel and a null voxel, and has a voxel center position expressed by integer coordinate components in the object coordinate system. The object volume further includes a plurality of object boundary points, each of which is located between a corresponding adjacent pair of the tissue and null voxels.

The method includes the steps of:

(a) receiving a select input corresponding to a selected type of the virtual tool, the selected type being selected from a group consisting of a cylindrical type, a frusto-conical type, a conical type, an ellipsoidal type, a paraboloid type, and combinations thereof;

(b) obtaining a plurality of tool boundary points of the virtual tool based on the selected type of the virtual tool;

(c) obtaining a current reference position of the virtual tool in the object coordinate system, the current reference position being temporally spaced apart from a previously obtained reference position of the virtual tool by a predefined haptic period;

(d) determining a current tool subvolume of the object volume in the object coordinate system based on the current reference position of the virtual tool and predefined dimensions of the virtual tool corresponding to the selected type in the object coordinate system; and

(e) upon determining that the current tool subvolume has at least one of the tissue voxels, performing the sub-steps of
(e-1) determining positions of the tool boundary points within the current tool subvolume based on the current reference position of the virtual tool and the predefined dimensions of the virtual tool,
(e-2) updating labels of the voxels within the current tool subvolume and replacing an original set of the object boundary points within the current tool subvolume with a new set of the object boundary points with reference to the positions of the tool boundary points determined in sub-step (e-1), and the voxel center positions of at least one of the tissue and null voxels within the current tool subvolume,
(e-3) determining force-contributing ones of the tool boundary points with reference to a feed direction from the previously obtained reference position of the virtual tool to the current reference position of the virtual tool, and
(e-4) providing force information of a force to be generated by the haptic simulating device according to the feed direction, a feed distance between the current and previously obtained reference positions of the virtual tool, the predefined dimensions of the virtual tool corresponding to the selected type of the virtual tool, a relationship between the positions of the force-contributing ones of the tool boundary points and the voxels within the current tool subvolume, and a predefined force parameter set.

The present invention provides a method that is more efficient and that permits surgery simulations using virtual tools of types other than the spherical burr type.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram for illustrating the environment of using a simulation system according to the preferred embodiment of the present invention;

FIG. 2 is a schematic diagram, illustrating a haptic simulating device of the simulation system according to the preferred embodiment;

FIGS. 3A and 3B cooperatively illustrate a flow chart, illustrating the method for generating real-time haptic response information according to the preferred embodiment;

FIG. 3C is a flowchart, illustrating sub-steps of sub-step S155 of the method for generating real-time haptic response information according to the preferred embodiment;

FIG. 4 is a schematic diagram, illustrating a user interface used for inputting a selected type of the virtual tool according to the preferred embodiment;

FIG. 5 is a schematic diagram, illustrating a tool boundary point initialization procedure for the virtual tool of a frusto-conical type;

FIG. 6 is a schematic diagram, illustrating a tool boundary point initialization procedure for the virtual tool of an ellipsoidal type;

FIG. 7 is a schematic diagram, illustrating the determination of a tool swept subvolume for the virtual tool of the ellipsoidal type;

FIG. 8 is a schematic diagram, illustrating the determination of a tool swept subvolume for the virtual tool of a spherical type;

FIG. 9 is a schematic diagram, illustrating the determination of a tool swept subvolume for the virtual tool of the frusto-conical type;

FIG. 10 is a schematic diagram, illustrating the determination of a tool swept subvolume for the virtual tool of a combination type that combines the cylindrical type and the ellipsoidal type;

FIG. 11 and FIG. 12 are schematic diagrams, illustrating rotation of a current orientation of the virtual tool in sub-step S152;

FIG. 13 is a schematic diagram, illustrating the determination of positions of a plurality of tool boundary points that are disposed within a current tool subvolume for the virtual tool of the frusto-conical type in sub-step S153;

FIG. 14 is a schematic diagram similar to FIG. 13 for the virtual tool of the ellipsoidal type;

FIG. 15 is a schematic diagram similar to FIG. 13 for the virtual tool of the paraboliod type;

FIG. 16 is a schematic diagram similar to FIG. 13 for the virtual tool of the combination type;

FIG. 17 is a schematic diagram, used for explaining justification for an approximation for a volume swept by the virtual tool within one haptic period;

FIGS. 18(a) to 18(c) are schematic diagrams, illustrating the determination of the changes made to an object volume by the virtual tool in sub-step S154;

FIGS. 19(a) to 19(d) are schematic diagrams of a simplified 2D example for illustrating a separation check procedure;

FIGS. 20(a) to 20(d) are schematic diagrams, respectively illustrating front, top, side and back views of an image construction of an object volume in an exemplary application;

FIGS. 21(a) and 21(b), FIGS. 22(a) and 22(b) and FIGS. 23(a) and 23(b) are schematic diagrams for illustrating the image constructions for the exemplary application of FIGS. 20(a) to 20(d) during a surgery simulation performed by a virtual tool;

FIGS. 24(a) to 24(c) are schematic diagrams for illustrating the image constructions of an object volume for another exemplary application during a surgery simulation performed by a virtual tool; and

FIG. 25 is a schematic diagram for illustrating the image construction of an object volume for yet another exemplary application during a surgery simulation performed by a virtual tool.

### DETAILED DESCRIPTION OF THE PREFERRED EMBODIMENT

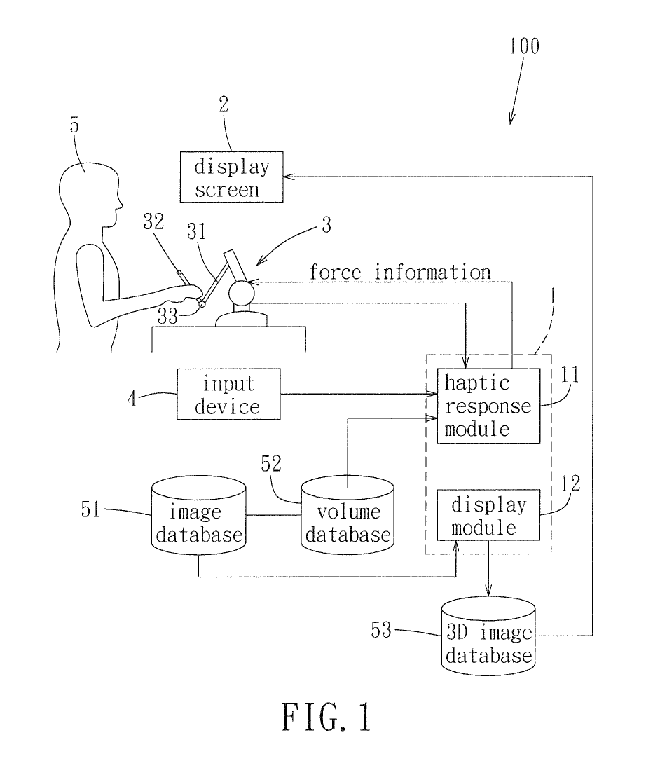

Referring to FIG. 1, a simulation system 100 according to the preferred embodiment of the present invention is shown to include a computing apparatus 1, a display screen 2, an input device 4, a storage device (not shown), and a haptic simulating device 3 coupled electrically to the computing apparatus 1. The storage device stores an image database 51, a volume database 52, and a three-dimensional (3D) image database 53.

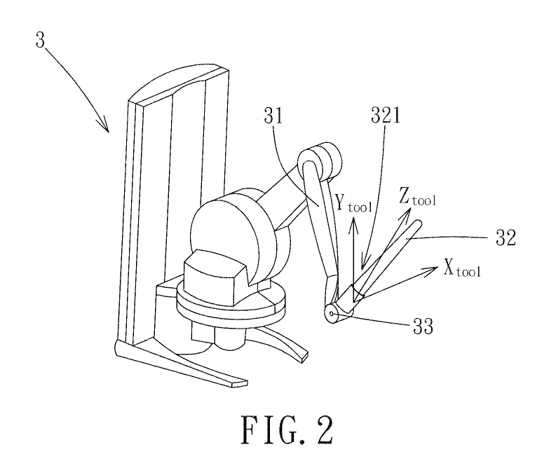

With reference to FIG. 2, the haptic simulating device 3 can be, for example, PHANTOM® Desktop Haptic Device by SensAble technologies, and includes a haptic arm 31, a handle 32, and a sensing ball 33. The haptic simulating device 3 provides a current reference position of the sensing ball 33 to the computing apparatus 1. The current reference position of the sensing ball 33 is the current reference position of a virtual tool, and is expressed in a three-dimensional (3D) object coordinate system. The object coordinate system is defined by first, second and third axes (X_{object}, Y_{object}, Z_{object}) that are orthogonal to each other. During a surgery simulation performed by the virtual tool that is associated with the haptic simulating device 3 on a 3D object volume that includes a plurality of uniformly-spaced-apart voxels, the handle 32 is held by a user 5 in order to move the haptic arm 31 and the sensing ball 33, and a force is generated by the haptic simulating device 3 and fed back via the haptic arm 31 and the handle 32 and felt by the user 5 so as to provide haptic response. Each of the voxels is labeled as one of a tissue voxel and a null voxel, and has a voxel center position expressed by integer coordinate components in the object coordinate system. The object volume further includes a plurality of object boundary points, each of which is located between a corresponding adjacent pair of the tissue and null voxels.

The method for generating real-time haptic response information for the haptic simulating device 3 during the surgery simulation according to the present invention is implemented by the computing apparatus 1 as configured by a program module (not shown) to provide force information related to strength and direction of the force to be generated by the haptic simulating device 3. It should be noted herein that the computing apparatus 1 not only controls the haptic response, but also controls visual response for the surgery simulation so as to provide the most realistic surgery environment for the user 5. Due to the difference in refreshing rates, two separate execution threads are used for visual response processing and haptic response processing. Thus, the program module includes a haptic response module 11 and a display module 12.

The image database 51 contains a plurality of image data sets. The image data sets correspond to pixels in two-dimensional (2D) image slices obtained from CAT-scan (CT) or magnetic resonance imaging (MRI) (and possibly other image slices generated by linear interpolation based on the image slices obtained from CT or MRI), and correspond to voxels in the object volume. Each of the image data sets contains a first-axis coordinate component, a second-axis coordinate component, a third-axis coordinate component, and a gray-scale value. The first, second and third-axis coordinate components are integer coordinate components, and cooperate to indicate the voxel center position of the corresponding one of the voxels.

The image data sets stored in the image database 51 are converted into voxel data sets that are to be stored in the volume database 52. The process for this conversion is disclosed in U.S. patent application Ser. No. 12/559,607, which is the basic application for the present CIP application, and is not described herein for the sake of brevity. Each of the voxel data sets represents a corresponding one of the voxels in the object volume, and contains a first-axis coordinate component, a second-axis coordinate component, a third-axis coordinate component, and a voxel label. The voxel label indicates the corresponding one of the voxels to be one of the tissue and null voxels. For the voxel data set that corresponds to each of the voxels in an adjacent pair of the tissue and null voxels, there is also a distance-level value that indicates a distance between the voxel center position of the corresponding voxel in the adjacent pair of the tissue and null voxels and the corresponding object boundary point that is located between the corresponding adjacent pair of the tissue and null voxels in a corresponding one of six directions (±X_{object}, ±Y_{object}, ±Z_{object}) along the first, second and third axes (X_{object}, Y_{object}, Z_{object}). The distance-level value ranges from 0 to 1, and is also stored in the volume database 52. Furthermore, the voxel data set corresponding to one of the voxels in an adjacent pair of the tissue and null voxels further contains a face flag, which indicates that the adjacent pair of the tissue and null voxels shares a boundary face in a corresponding one of six directions along the first, second and third axes (X_{object}, Y_{object}, Z_{object}).

The 3D image database 53 is used for storing a 3D visual output of the object volume with reference to the image data sets recorded in the image database 51 for display on the display screen 2. It should be noted herein that since the feature of the present invention does not reside in the execution thread for the visual response, further details of the same are omitted herein for the sake of brevity.

The input device 4 is used for inputting into the computing apparatus 1 a selected type of the virtual tool and dimensions of the virtual tool corresponding to the selected type. The haptic simulating device 3 outputs to the computing apparatus 1 operating information of the haptic simulating device 3, which includes the current reference position of the sensing ball 33 (i.e., the current reference position of the virtual tool) as represented by three coordinate components relative to the object coordinate system, the current orientation of the virtual tool as determined from three angular components (or three components of one vector) relative to the object coordinate system, and a current status of the virtual tool. The current status may be one of cutting and non-cutting. In case of a burring surgery, where the virtual tool is a ball-shaped rotatable burring tool, the current status is one of rotating (cutting) and non-rotating (non-cutting).

An initial state of the haptic simulating device 3 in each haptic step determines a tool coordinate system, which is defined by fourth, fifth and sixth axes (Xₜₒₒₗ, Yₜₒₒₗ, Zₜₒₒₗ), where the sixth axis (Zₜₒₒₗ) is a longitudinal axis defined by the handle 32 of the haptic simulating device 3, and the fourth and fifth axes (Xₜₒₒₗ, Yₜₒₒₗ) are computed with reference to the sixth axis (Zₜₒₒₗ) due to their orthogonal relationship to each other and to the sixth axis (Zₜₒₒₗ). In this embodiment, a button 321 of the handle 32 defines the fifth axis (Yₜₒₒₗ).

Moreover, since the object boundary points only exist between adjacent pairs of the tissue and null voxels, the distance level values are only computed for the voxels in the adjacent pairs of the tissue and null voxels. In addition, a voxel data set may have a maximum of six distance-level values, respectively representing the location of the object boundary points in the six directions (±X_{object}, ±Y_{object}, ±Z_{object}).

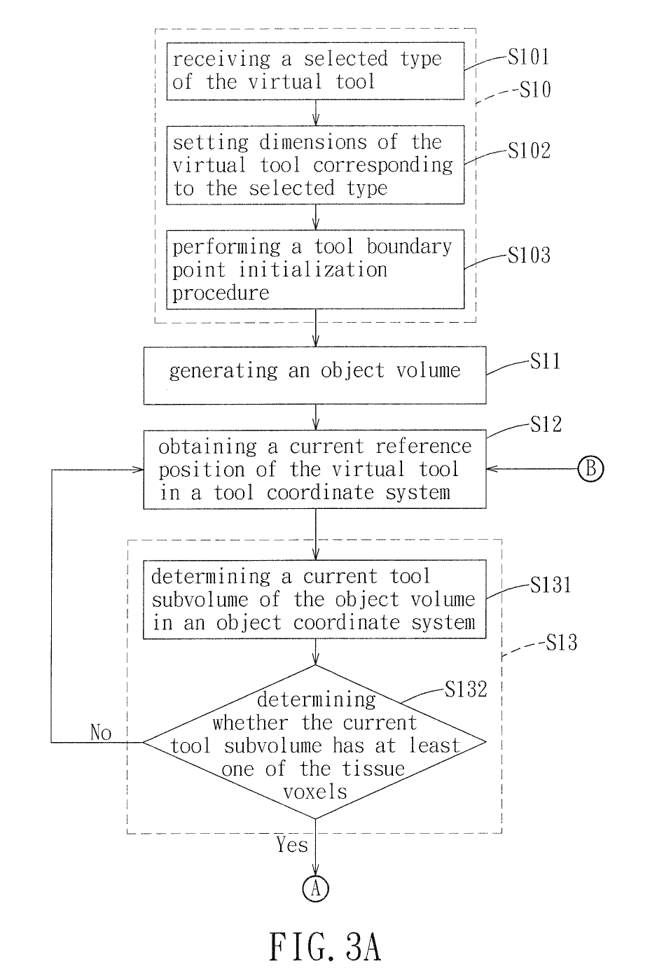

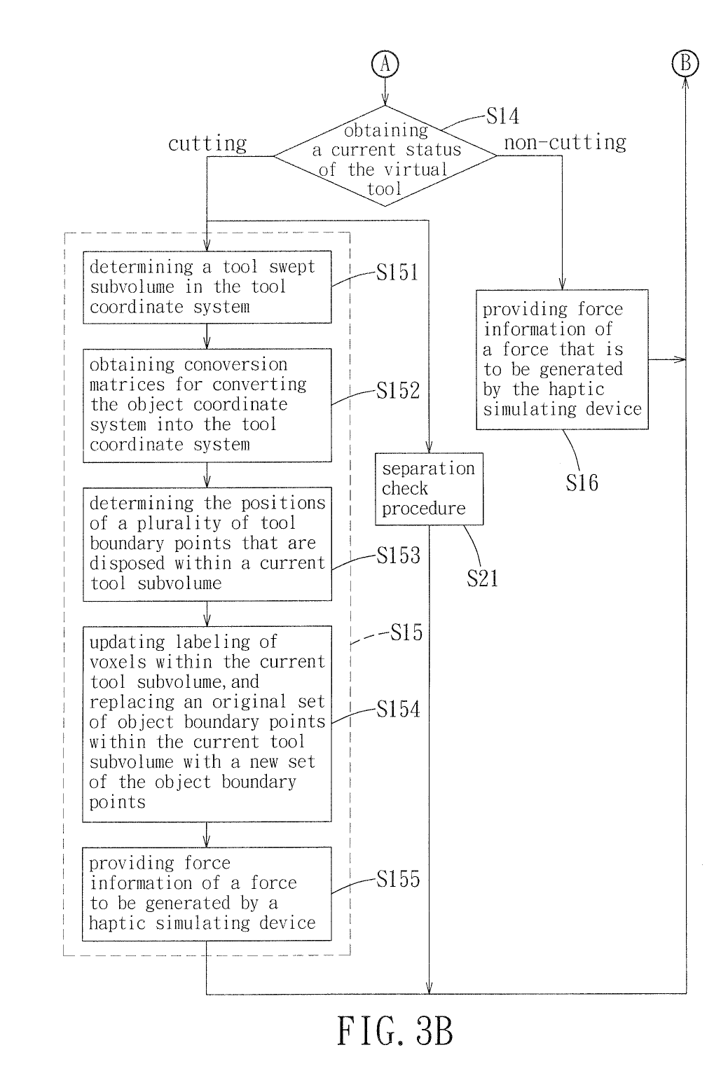

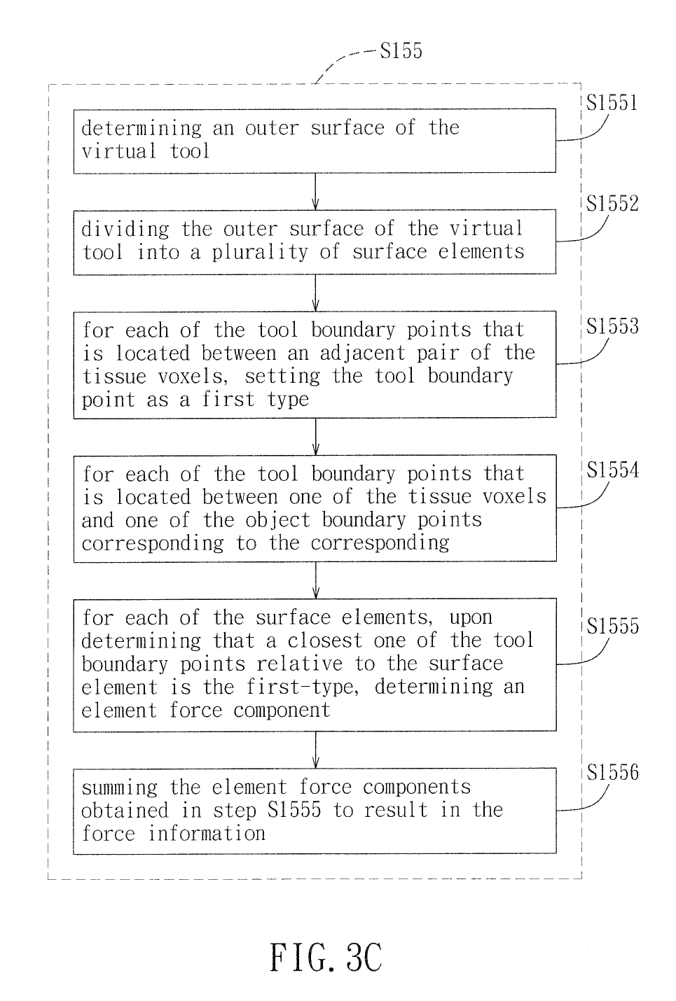

With reference to FIGS. 3A and 3B, detailed steps of the method for generating real-time haptic response information for the haptic simulating device 3 during a surgery simulation performed on an object volume by a virtual tool that is associated with the haptic simulating device 3 according to the preferred embodiment of the present invention are disclosed.

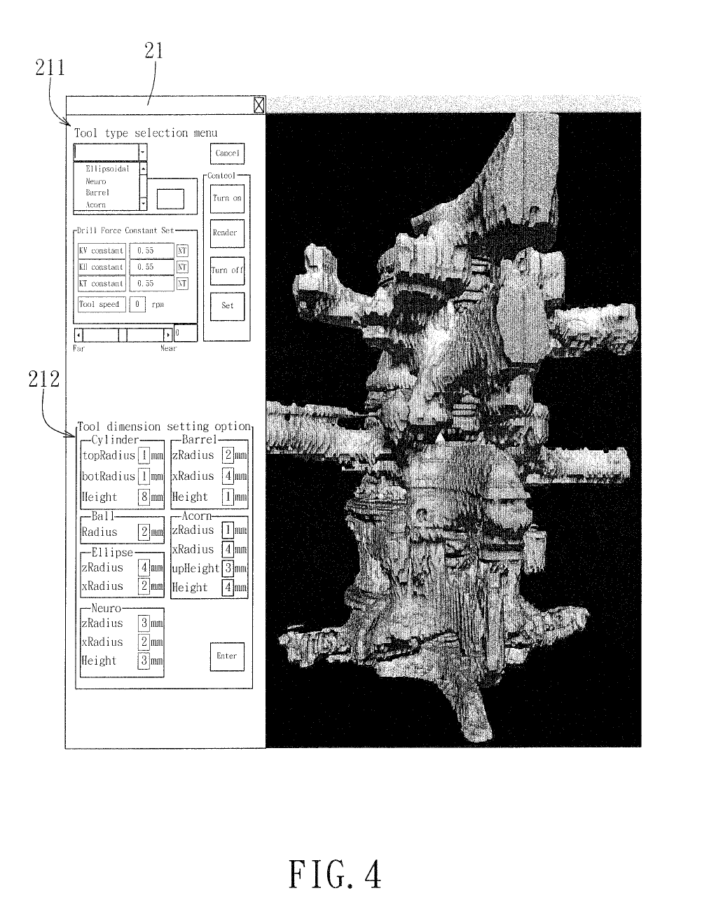

In step S10, a tool initialization procedure is performed. In this embodiment, step 10 includes three sub-steps. In sub-step S101, a select input corresponding to a selected type of the virtual tool is received. The selected type is selected from a group consisting of a cylindrical type (e.g., barrel burr, heliocoidal rasp, diamond disc, straight router, etc.), a frusto-conical type, a conical type, a spherical type (e.g., round fluted burr, round diamond burr, drum burr, etc.), an ellipsoidal type, a paraboloid type, and combinations (e.g., Acorn tool, which is composed of a cylindrical shape and a conical shape, Neuro tool, which is composed of a cylindrical shape and a semi-ellipsoid shape, Barrel tool, which is composed of a cylindrical shape and a semi-spherical shape, etc.) thereof. With further reference to FIG. 4, for instance, the user 5 (as shown in FIG. 1) may input the select input through the input device 4 to select from a tool type selection menu 211 of a user interface 21. In sub-step S102, the dimensions of the virtual tool corresponding to the selected type are set. For instance, the user 5 may input the dimension settings through the input device 4 to input desired dimensions in a tool dimension setting option 212 of the user interface 21. Next, in sub-step S103, a tool boundary point initialization procedure is performed, where a plurality of tool boundary points of the virtual tool are obtained based on the selected type of the virtual tool. In the following description, the tool boundary point initialization procedure for each of the frusto-conical type and the ellipsoidal type will be explained in detail.

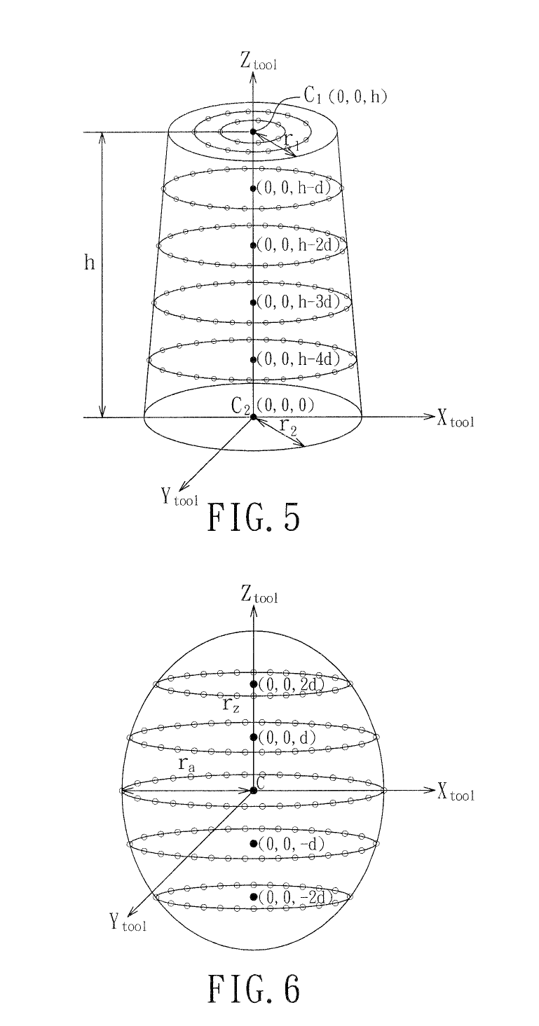

With reference to FIG. 5, for the frusto-conical type with a height of (h), a first radius of (r1) for a top surface of the frusto-cone centered at center (C1), and a second radius of (r2) for a bottom surface of the frusto-cone centered at center (C2), the virtual tool is initially defined such that the center (C2) of the bottom surface of the frusto-cone (corresponding to the sensing ball 33 of the haptic simulating device 3) is disposed on the origin of the tool coordinate system, and such that the height (h) of the frusto-cone extends in the sixth-axis (Zₜₒₒₗ) in the tool coordinate system. In other words, the center (C1) of the top surface of the frusto-cone is located at coordinate (0, 0, h), and the center (C2) of the bottom surface of the frusto-cone is located at coordinate (0, 0, 0) in the tool coordinate system. For the frusto-conical type, the tool boundary points only exist on the top surface and side surfaces. Assuming that a distance between the centers of two adjacent voxels is (d), for the top surface of the frusto-cone, the tool boundary points are located along the circumference of each circle centered at the center (C1) of the top surface and having a radius of r1−n1×d, where (n1) is an integer and

$$0 \leq n 1 \leq ⌊ \frac{r 1}{d} ⌋ ,$$

with the distance between two adjacent tool boundary points being (d). As for the side surfaces of the frusto-cone, the tool boundary points are located along the circumference of each circle centered along the sixth axis (Zₜₒₒₗ) and having a radius of

$$r 2 + ( h - n 2 \times d ) ( \frac{r 1 - r 2}{h} ) ,$$

where (n2) is an integer and

$$1 \leq n 2 \leq ⌊ \frac{h}{d} ⌋ ,$$

with the distance between two adjacent tool boundary points being (d). It should be noted herein that in the cases where the number of the tool boundary points located along the circumference of the same circle using the above method is not a factor of 360 degrees, the closest integer that is a factor of 360 degrees is taken to be the actual number of the tool boundary points for that circle. As a result, the distance between two adjacent tool boundary points for this kind of circumstances is no longer (d).

With reference to FIG. 6, for the ellipsoidal type with a first radius of (ra) and a second radius of (rz), the virtual tool is initially set such that the center (C) of the ellipsoid is disposed on the origin of the tool coordinate system, and such that the second radius (rz) of the frusto-cone extends in the sixth-axis (Zₜₒₒₗ) in the tool coordinate system. It is noted herein that the spherical type is a special case of the ellipsoidal type where ra=rz. The surface equation of an ellipsoid is

$${( \frac{{x}_{tool}}{ra} )}^{2} + {( \frac{{y}_{tool}}{ra} )}^{2} + {( \frac{{z}_{tool}}{rr} )}^{2} = 1.$$

As with the above, assuming that the distance between the centers of two adjacent voxels is (d), the tool boundary points of the ellipsoidal type are located along the circumference of each circle having a radius of

$$ra ( \sqrt{1 - {( \frac{q}{rz} )}^{2}} ) ,$$

where q=±n3×d and (n3) is an integer and

$$0 \leq n 3 \leq ⌊ \frac{r z}{d} ⌋ ,$$

with the distance between two adjacent tool boundary points being (d). As with the frusto-conical type, it should be noted herein that in the cases where the number of the tool boundary points located along the circumference of the same circle using the above method is not a factor of 360 degrees, the closest integer that is a factor of 360 degrees is taken to be the actual number of the tool boundary points for that circle. As a result, the distance between two adjacent tool boundary points for this kind of circumstances is no longer (d).

Referring back to FIGS. 3A and 3B, after the tool initialization procedure is completed in step S10, in step S11, the object volume is generated based on the volume database 52. Subsequently, in step S12, with the user 5 (as shown in FIG. 1) being allowed to operate the haptic simulating device 3, a current reference position of the virtual tool (i.e., the current reference position of the sensing ball 33) is obtained in the tool coordinate system. The current reference position is temporally spaced apart from a previously obtained reference position of the virtual tool by a predefined haptic period. Next, in step S13, it is determined whether the virtual tool contacts the object volume. Step S13 includes the following sub-steps. In sub-step S131, a current tool subvolume of the object volume is determined in the object coordinate system based on the current reference position of the virtual tool and the predefined dimensions of the virtual tool in the object coordinate system. It should be noted herein that details related to the determination of the current tool subvolume are disclosed in U.S. patent application Ser. No. 12/559,607, and are omitted herein for the sake of brevity. In sub-step S132, it is determined whether the current tool subvolume has at least one of the tissue voxels. If it is determined that the current tool subvolume has at least one of the tissue voxels, the flow goes to step S14. Otherwise, the flow goes back to step S12.

In step S14, a current status of the virtual tool (i.e., cutting or non-cutting) is obtained. If the current status is cutting, the process goes to step S15. Otherwise, the process goes to step S16.

In step S15, force information of a force to be generated by the haptic simulating device 3 is determined. Step S15 includes five sub-steps: sub-step S151, sub-step S152, sub-step S153, sub-step S154 and sub-step S155.

In sub-step S151, a tool swept subvolume is determined in the object coordinate system based on the current reference position of the virtual tool, the previously obtained reference position of the virtual tool, and the predefined dimensions of the virtual tool. The tool swept subvolume encloses both the virtual tool in the current haptic step and the virtual tool in the previous haptic step. Only the voxels within the tool swept subvolume are possibly removed during the haptic period. Therefore, the purpose of determining the tool swept subvolume is to define the maximum and minimum points in each of the first, second and third axes (X_{object}, Y_{object}, Z_{object}) of the object coordinate system for computation of the force information. In the following description, the determination of the tool swept subvolume for various types of the virtual tool are provided.

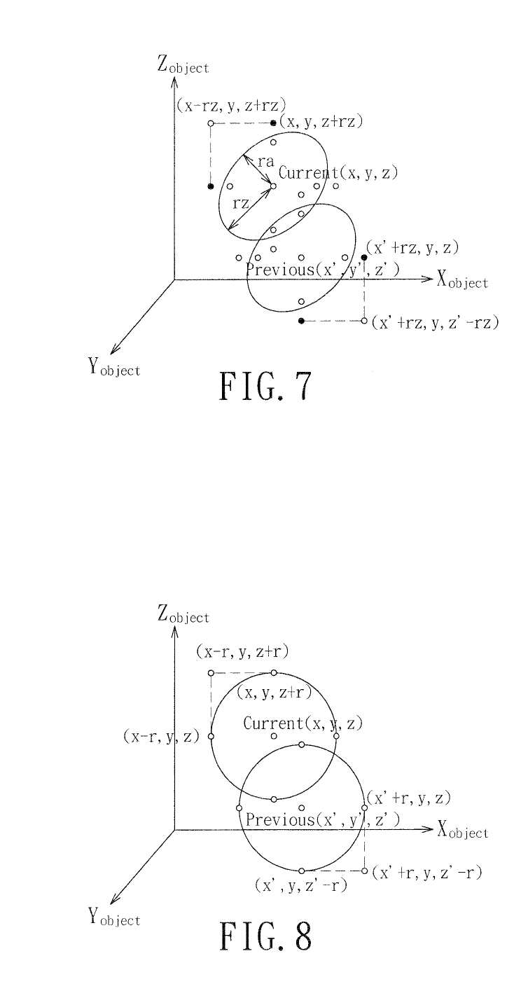

In this embodiment, the tool swept subvolume has the shape of a rectangular parallelepiped, and is determined by finding boundary of a cuboid that encloses the virtual tools of the previous and current haptic steps. FIG. 7 is a 2D image illustrating for simplicity the way of determining the tool swept subvolume for the ellipsoidal type. With a first radius of (ra), a second radius of (rz), a current reference position located at (x, y, z) in the object coordinate system, and a previous reference position located at (x′, y′, z′) in the object coordinate system, the coordinate component in the first axis (X_{object}) for the boundary of the cuboid has a minimum of min{(x−max{ra, rz}), (x′−max{ra, rz})} and a maximum of max{(x+max{ra, rz}), (x′+max{ra, rz})}, and the coordinate component in the third axis (Z_{object}) for the boundary of the cuboid has a minimum of min{(z−max{ra, rz}), (z′−max{ra, rz})} and a maximum of max{(z+max{ra, rz}), (z′+max{ra, rz})}. In this particular example shown in FIG. 7, the coordinate component in the first axis (X_{object}) for the boundary of the cuboid has a minimum of (x−rz) and a maximum of (x′+rz), and the coordinate component in the third axis (Z_{object}) for the boundary of the cuboid has a minimum of (z′−rz) and a maximum of (z+rz).

As shown in FIG. 8, in the special case of the ellipsoidal type where ra=rz, the virtual tool is actually the spherical type, and the coordinate component in the first axis (X_{object}) for the boundary of the cuboid would have a minimum of min{(x−ra), (x′−ra)} and a maximum of max{(x+ra), (x′+ra)}, and the coordinate component in the third axis (Z_{object}) for the boundary of the cuboid would have a minimum of min {(z−ra), (z′−ra)} and a maximum of max{(z+ra), (z′+ra)}. In this particular example shown in FIG. 8, the coordinate component in the first axis (X_{object}) for the boundary of the cuboid has a minimum of (x−ra) and a maximum of (x′+ra), and the coordinate component in the third axis (Z_{object}) for the boundary of the cuboid has a minimum of (z′−ra) and a maximum of (z+ra).

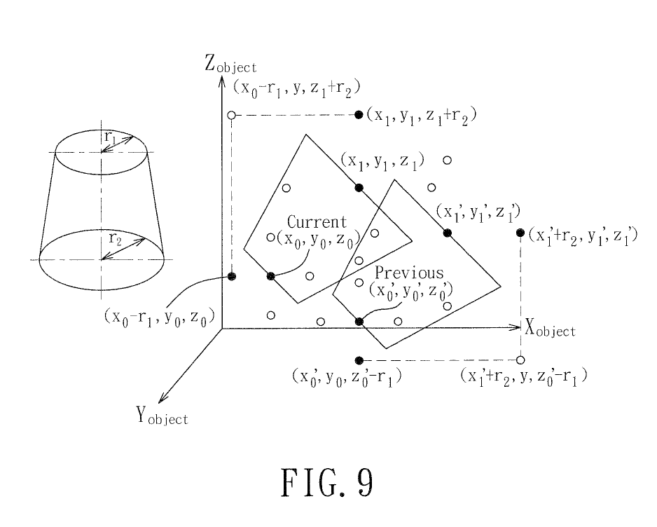

FIG. 9 is a 2D image illustrating for simplicity the way of determining the tool swept subvolume for the frusto-conical type. With a height of (h), a first radius of (r1) for a top surface of the frusto-cone, a second radius of (r2) for a bottom surface of the frusto-cone, a current center position of the top surface located at (x0, y0, z0) in the object coordinate system, a previous center position of the top surface located at (x0′, y0′, z0′) in the object coordinate system, a current center position of the bottom surface located at (x1, y1, z1) in the object coordinate system, and a previous center position of the bottom surface located at (x1′, y1′, z1′) in the object coordinate system, the coordinate component in the first axis (X_{object}) for the boundary of the cuboid has a minimum of min{(x0−r1), (x0′−r1), (x1−r2), (x1′−r2)}, and a maximum of max{(x0+r1), (x0′+r1), (x1+r2), (x1′+r2)}, and the coordinate component in the third axis (Z_{object}) for the boundary of the cuboid has a minimum of min{(z0−r1), (z0′−r1), (z1−r2), (z1′−r2)} and a maximum of max{(z0+r1), (z0′+r1), (z1+r2), (z1′+r2)}. In this particular example shown in FIG. 9, the coordinate component in the first axis (X_{object}) for the boundary of the cuboid has a minimum of (x0−r1) and a maximum of (x1′+r2), and the coordinate component in the third axis (Z_{object}) for the boundary of the cuboid has a minimum of (z0′−r1) and a maximum of (z1+r2). It should be noted herein that the haptic simulating device 3 outputs three coordinate components and three angular components of the location of the sensing ball 33 (i.e., the reference position of the virtual tool) relative to the object coordinate system, and therefore coordinates of the current and previous center positions of the top and bottom surfaces of the frusto-cone are computed results based on the three coordinate components and the three angular components outputted by the haptic simulating device 3 and the predefined dimensions of the frusto-cone.

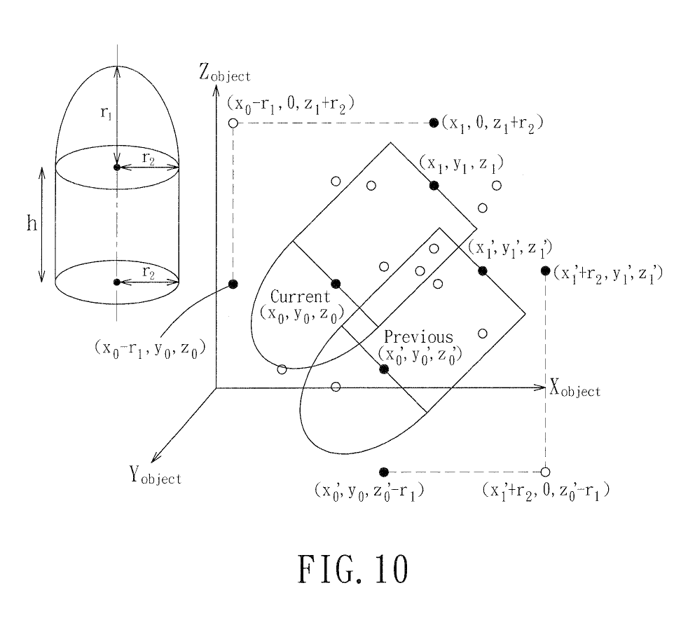

FIG. 10 is a 2D image illustrating for simplicity the way of determining the tool swept subvolume for the combination of the cylindrical type and the ellipsoidal type, which has the shape of a semi-ellipsoid combined with a cylinder. The semi-ellipsoid has a first radius of (r1) and a second radius of (r2), whereas the cylinder has a radius of (r2) and a height of (h). With a current center position of a top surface of the cylinder located at (x0, y0, z0) in the object coordinate system, a previous center position of the top surface located at (x0′, y0′, z0′) in the object coordinate system, a current center position of a bottom surface of the cylinder located at (x1, y1, z1) in the object coordinate system, and a previous center position of the bottom surface located at (x1′, y1′, z1′) in the object coordinate system, the coordinate component in the first axis (X_{object}) for the boundary of the cuboid has a minimum of min{(x0−max{r1, r2}), (x0′−max{r1, r2}), (x1−r2), (x1′−r2)}, and a maximum of max{(x0+max{r1, r2}), (x0′+max{r1, r2}), (x1+r2), (x1′+r2)}, and the coordinate component in the third axis (Z_{object}) for the boundary of the cuboid has a minimum of min{(z0−max{r1, r2}), (z0−max{r1, r2}), (z1−r2), (z1′−r2)} and a maximum of max{(z0+max{r1, r2}), (z0′+max{r1, r2}), (z1+r2), (z1′+r2)}. In this particular example shown in FIG. 10, the first radius (r1) is greater than the second radius (r2), and the coordinate component in the first axis (X_{object}) for the boundary of the cuboid has a minimum of (x0−r1) and a maximum of (x1′+r2), and the coordinate component in the third axis (Z_{object}) for the boundary of the cuboid has a minimum of (z0′−r1) and a maximum of (z1+r2). As with the above, coordinates of the current and previous center positions of the top and bottom surfaces of the cylinder are computed results based on the three coordinate components and the three angular components outputted by the haptic simulating device 3 and the predefined dimensions of the semi-ellipsoid and the cylinder.

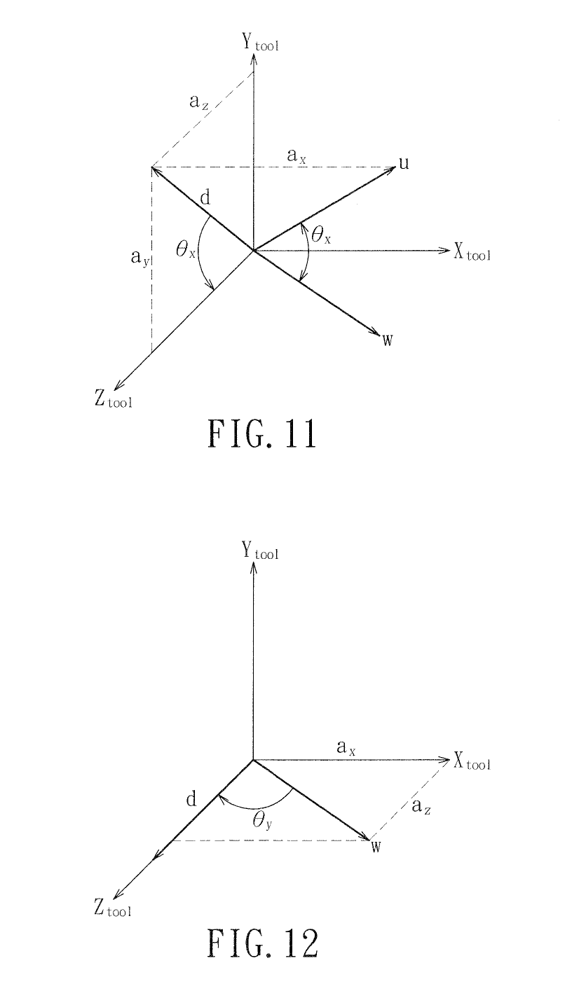

Referring back to FIG. 3B, in sub-step S152, conversion matrices for converting the object coordinate system into the tool coordinate system are obtained. As shown in FIG. 2, the tool coordinate system is defined by the haptic simulating device 3, where the sixth axis (Zₜₒₒₗ) is a longitudinal axis defined by the handle 32 of the haptic simulating device 3 at an initial orientation, a button 321 of the handle 32 defines the fifth axis (Yₜₒₒₗ), and the fourth axis (Xₜₒₒₗ) is orthogonal to the fifth and sixth axes (Yₜₒₒₗ, Zₜₒₒₗ). It is assumed that vector u=[aₓ, a_{y}, a_{z}] represents a line that is parallel to one of the first, second and third axes (X_{object}, Y_{object}, Z_{object}) of the object coordinate system, and is defined by angular components (θₓ, θ_{y}, θ_{z}) in the tool coordinate system. With reference to FIG. 11 and FIG. 12, the conversion matrices are obtained by first rotating the vector (u) by angle (θₓ) to the Xₜₒₒₗ−Zₜₒₒₗ plane so as to obtain a new vector (w), and then rotating the vector (w) by angle (θ_{y}) such that a new vector coincides with the sixth axis (Zₜₒₒₗ). The conversion matrices denoted by Rₓ(θₓ) and R_{y}(θ_{y}) are defined as follows:

$${R}_{x} ( {θ}_{x} ) = [ \begin{matrix}1 & 0 & 0 \\ 0 & cos {θ}_{x} & - sin {θ}_{x} \\ 0 & sin {θ}_{x} & cos {θ}_{x}\end{matrix} ] = [ \begin{matrix}1 & 0 & 0 \\ 0 & {a}_{z} / d & - {a}_{y} / d \\ 0 & {a}_{y} / d & - {a}_{z} / d\end{matrix} ]$$

$${R}_{y} ( {θ}_{y} ) = [ \begin{matrix}cos {θ}_{y} & 0 & - sin {θ}_{y} \\ 0 & 1 & 0 \\ sin {θ}_{y} & 0 & cos {θ}_{y}\end{matrix} ] = [ \begin{matrix}d & 0 & - {a}_{x} \\ 0 & 1 & 0 \\ {a}_{x} & 0 & d\end{matrix} ]$$

where d=\sqrt{a_{y}²+a_{z}²}, sin θₓ=a_{y}/d, cos θₓ=a_{z}/d sin θ_{y}=aₓ, and cos θ_{y}=d.

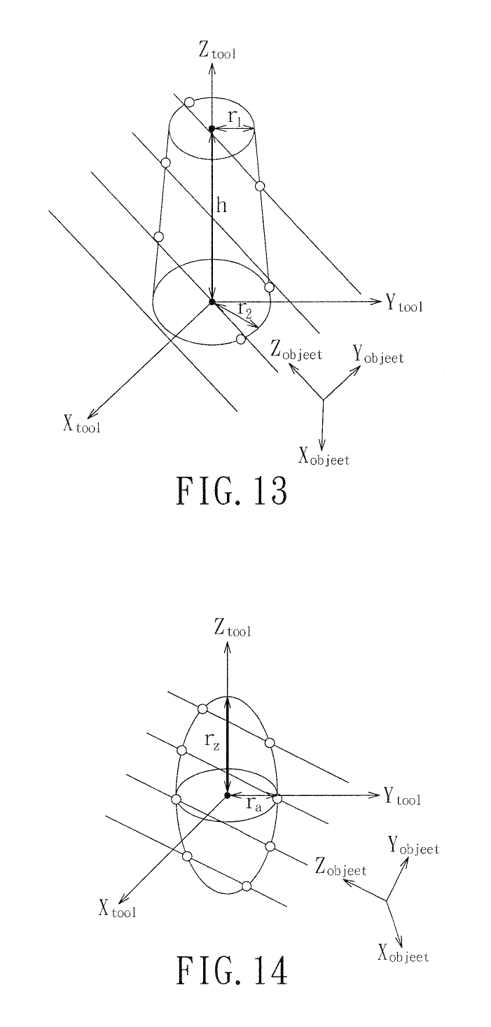

Subsequently, in sub-step S153, the positions of the tool boundary points that are disposed within the current tool subvolume are determined based on the current reference position of the virtual tool and the predefined dimensions of the virtual tool. In particular, the position of each of the tool boundary points is determined by locating a corresponding intersection between an outer surface of the virtual tool that is determined from the current center position of the virtual tool and the predefined dimensions of the virtual tool corresponding to the selected type, and a corresponding line that is parallel to one of the first, second and third axes (X_{object}, Y_{object}, Z_{object}), and that has integer coordinate components in the other two of the first, second and third axes (X_{object}, Y_{object}, Z_{object}). In the following descriptions with reference to FIGS. 13 to 16, a hollow circle (◯) represents an intersection.

With reference to FIG. 13, when the selected type of the virtual tool is the frusto-conical type, the predefined dimensions of the virtual tool corresponding to the frusto-conical type include a height of (h), a first radius of (r1) for a top surface of the frusto-cone, and a second radius of (r2) for a bottom surface of the frusto-cone. The intersections are located in sub-step 153 by substituting

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {x}^{2} + {y}^{2} = {[ r 2 + z ( \frac{r 1 - r 2}{h} ) ]}^{2}$$

so as to obtain

$$t = \frac{- B \pm \sqrt{{B}^{2} - AC}}{A} , where {x}^{2} + {y}^{2} = {[ r 2 + z ( \frac{r 1 - r 2}{h} ) ]}^{2}$$

represents a surface quadratic equation of the virtual tool of the frusto-conical type in the tool coordinate system, 0≦z≦h, and

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

represents the line that is parallel to one of the first, second and third axes (X_{object}, Y_{object}, Z_{object}) of the object coordinate system expressed in the tool coordinate system and where A=(v′ₓ²+v′_{y}²−a²), B=(v′ₓp′ₓ+v′_{y}p′ₓ−ab), C=(p′ₓ²+p′ₛ²−b²),

$$a = ( \frac{r 1 - r 2}{h} ) {v}_{z}^{′} , and b = r 2 + ( \frac{r 1 - r 2}{h} ) {p}_{z}^{′} ,$$

and followed by substituting

$$t = \frac{- B \pm \sqrt{{B}^{2} - AC}}{A}$$

back into

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

to obtain coordinates of the intersections in the tool coordinate system when the condition of 0≦z≦h is satisfied.

It is apparent from FIG. 13 that the intersections may exist between the lines that are parallel to the first, second and third axes (X_{object}, Y_{object}, Z_{object}) and one of the top surface of the frusto-cone, the bottom surface of the frusto-cone, and the side surfaces of the frusto-cone. Therefore, in order to save computation time (or the amount of computations involved), sub-step 153 may be performed as follows.

The intersection between the outer surface of the virtual tool of the frusto-conical type other than the top and bottom surfaces and the line that is parallel to one of the first, second and third axes (X_{object}, Y_{object}, Z_{object}) of the object coordinate system is located by substituting

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {x}^{2} + {y}^{2} = {[ r 2 + z ( \frac{r 1 - r 2}{h} ) ]}^{2}$$

so as to obtain an expression of t in terms of v′ₓ, v′_{y}, v′_{z}, p′ₓ, p′_{y}, p′_{z}, r1, r2 and h, followed by substituting the expression of t into

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

so as to obtain x, y and z coordinates of the intersection in a tool coordinate system when the condition of 0<z<h is satisfied, where

$${x}^{2} + {y}^{2} = {[ r 2 + z ( \frac{r 1 - r 2}{h} ) ]}^{2}$$

represents a surface quadratic equation of the virtual tool of the frusto-conical type in the tool coordinate system, 0≦z≦h, and

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

represents the line that is parallel to one of the first, second and third axes of the object coordinate system expressed in the tool coordinate system.

The intersection between the bottom surface of the virtual tool of the frusto-conical type and the line that is parallel to one of the first, second and third axes (X_{object}, Y_{object}, Z_{object}) of the object coordinate system is located by substituting z=0 into z=v′_{z}t+p′_{z} to obtain an expression of t in terms of v′_{z} and p′_{z}, followed by substituting the expression of t into x=v′ₓt+p′ₓ and y=v′_{y}t+p′_{y} to obtain x and y coordinates of the intersection in the tool coordinate system when the condition of x²+y²≦r2² is satisfied.

The intersection between the top surface of the virtual tool of the frusto-conical type and the line that is parallel to one of the first, second and third axes (X_{object}, Y_{object}, Z_{object}) of the object coordinate system is located by substituting z=h into z=v′_{z}t+p′_{z} to obtain an expression of t in terms of v′_{z} and p′_{z}, followed by substituting the expression of t into x=v′ₓt+p′ₓ and y=v′_{y}t+p′_{y} to obtain x and y coordinates of the intersection in the tool coordinate system when the condition of x²+y²≦r1² is satisfied.

With reference to FIG. 14, when the selected type of the virtual tool is the ellipsoidal type, the predefined dimensions of the virtual tool corresponding to the ellipsoidal type include a first radius of (ra) and a second radius of (rz).

The intersections are located in sub-step S153 by substituting

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {( \frac{x}{ra} )}^{2} + {( \frac{y}{ra} )}^{2} + {( \frac{z}{rz} )}^{2} = 1$$

so as to obtain

$$t = \frac{- B \pm \sqrt{{B}^{2} - AC}}{A} , where {( \frac{x}{ra} )}^{2} + {( \frac{y}{ra} )}^{2} + {( \frac{z}{rz} )}^{2} = 1$$

represents a surface quadratic equation of the virtual tool of the ellipsoidal type in a tool coordinate system, and

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

represents the line that is parallel to one of the first, second and third axes (X_{object}, Y_{object}, Z_{object}) of the object coordinate system expressed in the tool coordinate system, and where A=(a²+b²+c²), B=(ai+bj−ck), C=(i²+j²+k²−1),

$$a = \frac{{v}_{x}^{′}}{r a} , b = \frac{{v}_{y}^{′}}{r a} , c = \frac{{v}_{z}^{′}}{r z} , i = \frac{{p}_{x}^{′}}{r a} , j = \frac{{p}_{y}^{′}}{r a} , and k = \frac{{p}_{z}^{′}}{r z} ,$$

followed by substituting

$$t = \frac{- B \pm \sqrt{{B}^{2} - AC}}{A}$$

back into

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

to obtain x, y and z coordinates of the intersection in the tool coordinate system when the condition of −rz<z<rz is satisfied.

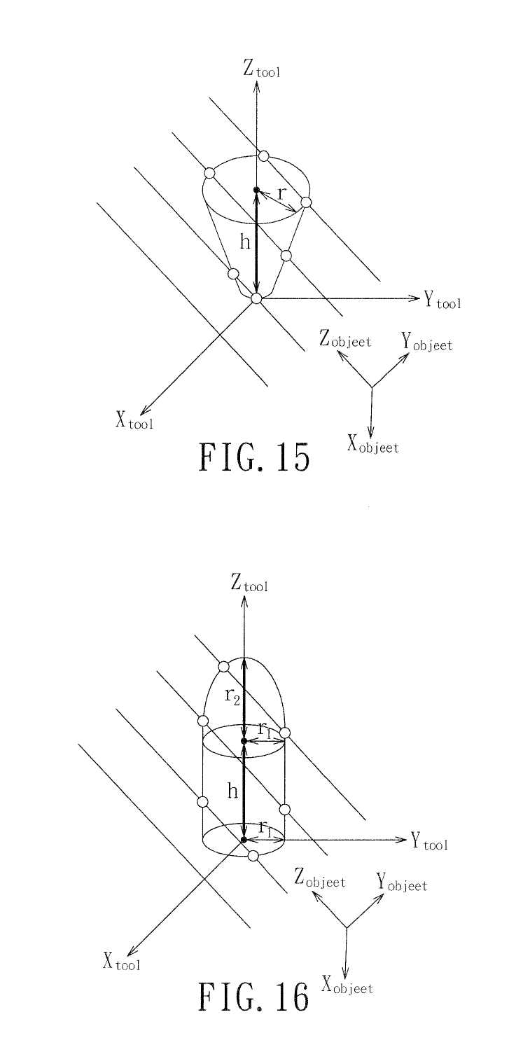

With reference to FIG. 15, when the selected type of the virtual tool is the paraboloid type, the predefined dimensions of the virtual tool corresponding to the paraboloid type include a radius of (r), and a height of (h). The intersections are located in sub-step 153 by substituting

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {( \frac{x}{r} )}^{2} + {( \frac{y}{r} )}^{2} = z$$

so as to obtain

$$t = \frac{- B \pm \sqrt{{B}^{2} - AC}}{A} , where {( \frac{x}{r} )}^{2} + {( \frac{y}{r} )}^{2} = z$$

represents a surface quadratic equation of the virtual tool of the paraboloid type in a tool coordinate system, and

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

represents the line that is parallel to one of the first, second and third axes (X_{object}, Y_{object}, Z_{object}) of the object coordinate system expressed in the tool coordinate system, and where A=(v′ₓ²+v′_{y}²),

$$B = ( {v}_{x}^{′} {p}_{x}^{′} + {v}_{y}^{′} {p}_{y}^{′} - \frac{{r}^{2}}{2} {v}_{z}^{′} ) ,$$

and C=(p′ₓ²+p′_{y}²+r²p′_{z}), followed by substituting

$$t = \frac{- B \pm \sqrt{{B}^{2} - AC}}{A}$$

back into

$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$

to obtain x, y and z coordinates of the intersection in the tool coordinate system when the condition of 0≦z≦h is satisfied.

With reference to FIG. 16, when the selected type of the virtual tool is a combination of the cylindrical type and the ellipsoidal type, and is a semi-ellipsoid combined with a cylinder (e.g., a Neuro burr), the intersections are located in sub-step 153 by locating intersections between the outer surface of the virtual tool of the cylindrical type that has the predefined dimensions of a radius of (r1) and a height of (h) along the sixth axis (Zₜₒₒₗ) in the tool coordinate system, and the line that is parallel to one of the first, second and third axes (X_{object}, Y_{object}, Z_{object}) of the object coordinate system for 0≦z≦h, and by locating intersections between the outer surface of the virtual tool of the ellipsoidal type that has the predefined dimensions of a first radius of (r1) and a second radius of (r2), and the line that is parallel to one of the first, second and third axes (X_{object}, Y_{object}, Z_{object}) of the object coordinate system for h<z<h+r2.

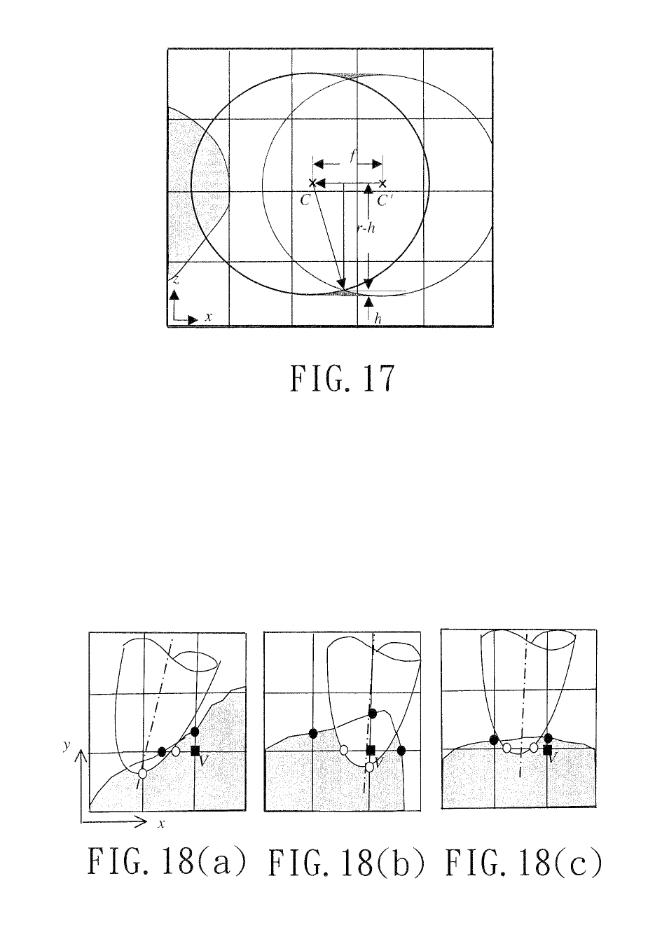

It should be noted herein that the volume removed by the virtual tool within one haptic period is approximated to be the volume covered by the virtual tool located at the current reference position and the previous reference position. This approximation is justified under a feed rate of within 100 mm/s of the virtual tool due to the following reasons. With reference to FIG. 17, in practice, since the virtual tool moves in a sweeping motion, the volume removed by the virtual tool should include the parts that are swept by the movement of the virtual tool. The substantially triangular parts near the top and bottom portions of FIG. 17 represent the errors between the reality and the approximation, and (C) and (C′) respectively represent the current and previous reference positions of the virtual tool. Assuming that the haptic period is 1/1000 seconds, a feed distance of the virtual tool within the haptic period is (f) the virtual tool has a radius of (r), and a greatest error has a length of (h), then h=r−\sqrt{r²−(0.5f)²}. Under a greater radius (r) and a smaller voxel width, the length of the greatest error (h) gets bigger. When (h) is 0.65 times one distance level, i.e., 1 mm, the feed rate of the virtual tool is 100 mm/s, the distance level is smaller than 1, and the error can be ignored.

Referring back to FIG. 3B, next, in sub-step S154, labeling of the voxels within the current tool subvolume are updated, and an original set of the object boundary points within the current tool subvolume is replaced with a new set of the object boundary points with reference to the positions of the tool boundary points determined in sub-step S153, and the voxel center positions of at least one of the tissue and null voxels within the current tool subvolume.

Sub-step S154 is performed to manipulate the object volume and update the volume database 52 (as shown in FIG. 1) by determining what changes are made to the object volume by the virtual tool (i.e., which tissues are removed by the virtual tool) in this haptic step. In FIGS. 18(a), 18(b) and 18(c), a solid square (▪) represents a tissue voxel, a solid circle () represents an object boundary point, and a hollow circle (◯) represents a tool boundary point. Referring to FIG. 18(a), the virtual tool does not remove the tissue voxel labeled (V), and removes the object boundary point disposed on the −x direction of the tissue voxel labeled (V). Referring to FIG. 18(b), the virtual tool removes the tissue voxel labeled (V) (i.e., the tissue voxel labeled (V) is replaced by a null voxel), as well as the object boundary point disposed on the +y direction of the tissue voxel labeled (V), and sets the tool boundary point in the −y direction of the tissue voxel labeled (V) as a new object boundary point. Referring to FIG. 18(c), the virtual tool does not remove the tissue voxel labeled (V), nor does it remove the object boundary points shown therein. The tool boundary points are not set as new object boundary points because there can be no object boundary point between two adjacent tissue voxels. Therefore, it is essentially determined that there is no tissue removal. However, this kind of cases is extremely rare.

In a simpler implementation, in order to reduce computations, the tool boundary points are located dynamically with reference to a feed direction of the virtual tool from the previously obtained reference position of the virtual tool to the current reference position of the virtual tool and a central axis of the virtual tool. For instance, when the configuration of the virtual tool is symmetrical with respect to the fourth, fifth and sixth axes (Xₜₒₒₗ, Yₜₒₒₗ, Zₜₒₒₗ), e.g., of the spherical type, the tool boundary points are only located on half of the virtual tool closest to the tip of the virtual tool. When the configuration of the virtual tool is elongated in a direction parallel to the central axis of the virtual tool, e.g., of the cylindrical type, the ellipsoidal type, and the combinations of these types, the tool boundary points are located according to the feed direction of the virtual tool. For instance, for the virtual tool of the cylindrical type, when the feed direction is parallel to the central axis, the tool boundary points are only located on the top surface of the cylinder, and when the feed direction is perpendicular to the central axis, the tool boundary points are only located on the side surface of the cylinder that is perpendicular to the feed direction.

Referring back to FIG. 3B, in sub-step S155, force information of a force to be generated by the haptic simulating device 3 is provided according to the feed direction from the previously obtained reference position of the virtual tool to the current reference position of the virtual tool, a feed distance between the current and previously obtained reference positions of the virtual tool, the predefined dimensions of the virtual tool, a relationship between the positions of the tool boundary points and the voxels within the current tool subvolume, and a predefined force parameter set.

With reference to FIG. 3C, sub-step 155 includes the following sub-steps in this embodiment.

In sub-step S1551, an outer surface of the virtual tool is determined according to the current reference position of the virtual tool and the predefined dimensions of the virtual tool.

In sub-step S1552, the outer surface of the virtual tool is divided into a plurality of surface elements (A).

In sub-step S1553, for each of the tool boundary points that is located between an adjacent pair of the tissue voxels, the tool boundary point is set as a first type.

In sub-step S1554, for each of the tool boundary points that is located between one of the tissue voxels and one of the object boundary points corresponding to the corresponding adjacent pair of the tissue and null voxels, the tool boundary point is set as the first type.

In sub-step S1555, for each of the surface elements (A), upon determining that a closest one of the tool boundary points relative to the surface element (A) is the first-type, an element force component is determined according to the feed direction, the feed distance, and an area of the surface element (A).

In sub-step S1556, the element force components obtained in sub-step S1555 are summed to result in the force information. The force information essentially includes strength of three direction force components F_{X}, F_{Y}, F_{Z} along the fourth, fifth and sixth axes (Xₜₒₒₗ, Yₜₒₒₗ, Zₜₒₒₗ) of the tool coordinate system.

Specifically, in sub-step S1555, the element force component includes first, second, third and fourth element sub-components. The first element sub-component is in a direction opposite to a rotation direction of the virtual tool. The second element sub-component is in a direction orthogonal to the rotation direction. The third element sub-component is in a direction opposite to a longitudinal axis of the virtual tool. The fourth element sub-component is in a direction opposite to the feed direction. Strengths of the first, second, third and fourth element sub-components are determined according to the following equations:

F_{tan g}=KₕdAfᵣₐₜₑ

F_{radial}=KᵣdAfᵣₐₜₑ

Fₐₓᵢₐₗ=KₐdAfᵣₐₜₑ

Fₜₕᵣᵤₛₜ=KₜdAfᵣₐₜₑ

where F_{tan g} represents the first element sub-component, F_{radial} represents the second element sub-component, Fₐₓᵢₐₗ represents the third element sub-component, Fₜₕᵣᵤₛₜ represents the fourth element sub-component, Kₕ, Kᵣ, Kₐ and Kₜ represent predefined force parameters in the predefined force parameter set respectively corresponding to the first, second, third and fourth element sub-components, dA represents the area of the surface element (A), and fᵣₐₜₑ represents a feed rate of the virtual tool and is a product of the feed distance and the predefined haptic period.

Recall that if it is determined in step S14 that the current status of the virtual tool is non-cutting, the process goes to step S16. In step S16, force information of a force that is to be generated by the haptic simulating device 3 in a direction opposite to the feed direction and that has a predefined strength is provided. This force is a repulsive force provided to notify the user 5 (as shown in FIG. 1) that the virtual tool is in contact with the tissue.

It should be further noted herein that the method of the present invention may also apply to an object volume whose voxels are categorized into more than two types (not just tissue voxel and null voxel). For instance, the tissue voxels may represent one of skin voxel, bone voxel, muscle voxel, nerve voxel, etc., the labelling of which is determined based on the gray-scale values corresponding thereto. In such instance, there will be different sets of predefined force parameters for different types of the tissues for use in force information computations, and the image constructed from the voxel data sets will have different colours.

Furthermore, reference may be made to U.S. patent application Ser. No. 12/559,607 for further details related to the computations of the force information.

In this embodiment, a separation check procedure (step S21 as shown in FIG. 3B) is performed by the method of the present invention to determine if the object volume contains at least two separate groups of tissue voxels that form two separate tissue structures.

Recall that the voxel data set corresponding to one of the voxels in an adjacent pair of the tissue and null voxels further contains the face flag that indicates that the adjacent pair of the tissue and null voxels shares a boundary face in a corresponding one of six directions along the first, second and third axes (X_{object}, Y_{object}, Z_{object}). Sub-step S154 further includes updating the voxel data sets of the voxels within the current tool subvolume with reference to the positions of the tool boundary points determined in sub-step S153, and the voxel center positions of at least one of the tissue and null voxels within the current tool subvolume. When at least one boundary face cannot be connected to the other boundary faces, it is determined that the object volume contains at least two separate groups of tissue voxels that form two separate tissue structures with reference to the face flags of the updated voxel data sets.

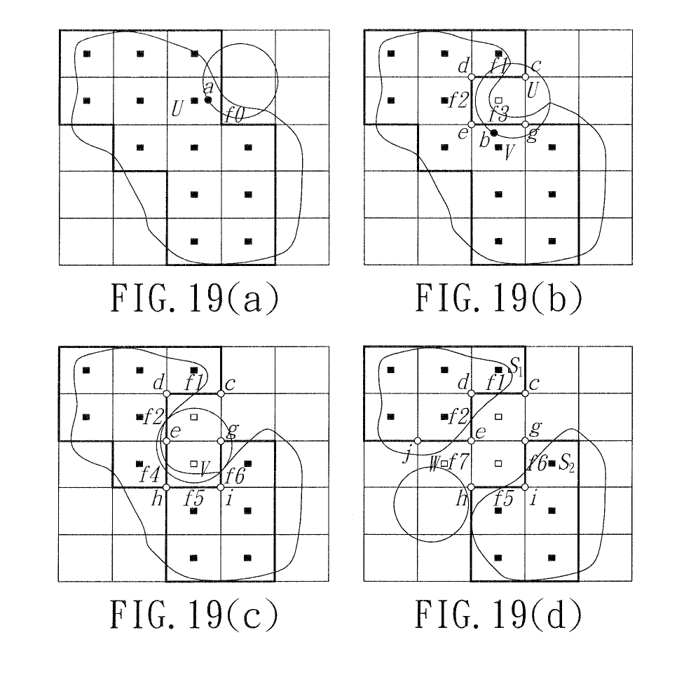

In the simplified 2D example shown in FIGS. 19(a) to 19(d), each gray area represents an independent tissue structure, the bold black lines represent the boundary faces, each big hollow circle represents the virtual tool, the solid squares (▪) represent tissue voxels, the solid circles () represent tool boundary points, and a hollow circle (◯) represents an edge of new boundary faces.

By manipulating the distance-level values with the intersections of the virtual tool with lines parallel to the first, second and third axes (X_{object}, Y_{object}, Z_{object}), tissue surface changes caused by cutting can be simulated. For example, a tool boundary point (a) (shown in FIG. 19(b)) is located between the center of a tissue voxel and the tissue surface represented by the voxel distance-level, and is therefore set as a new object boundary point. The distance-level value is renewed to represent this new object boundary point. Another tool boundary point (b) (shown in FIG. 19(b)) is located between centers of two tissue voxels (respectively labeled (U) and (V)), and thus the tissue voxel (U) is replaced with a null voxel. Accordingly, this null voxel would have face-flags indicating the presence of new boundary faces (f1), (f2) and (f3) (shown in FIG. 19(a)). Meanwhile, an original boundary face labeled (f0) (shown in FIG. 19(a)) is deleted.

All boundary faces of an independent tissue structure should be connected together. However, it would be time consuming to check all of them to determine if there are now two or more separate tissue structures after a cutting operation by the virtual tool. Therefore, in order to save computation time, this method only checks if the new boundary faces generated from the replacement of each tissue voxel with a null voxel are connected.

In this embodiment, four edges of every new boundary face are recorded. For each recorded edge, all new boundary faces that share this edge in common are also recorded for this edge. If a shared boundary face is an original boundary face, the original boundary face is not recorded for the recorded edge. For example, referring to FIGS. 19(a) to 19(d), when the tissue voxel labeled (U) is replaced with a null voxel, only one boundary face (f1) is recorded for the edge (c), and only one boundary face (f3) is recorded for edge (g). The other boundary faces at each of the edges (c) and (g) are original boundary faces and therefore are not recorded. Similarly, two boundary faces (f1) and (f2) are recorded for edge (d), and two boundary faces (f2) and (f3) are recorded for edge (e).

With reference to FIG. 19(b) and FIG. 19(c), when the tissue voxel (V) is replaced with a null voxel, the boundary face (f3) is deleted, and new boundary faces (f4), (f5) and (f6) are generated. Accordingly, the boundary faces that are recorded for the edge (e) are now (f2) and (f4), the boundary face recorded for the edge (g) is (f6), the boundary faces recorded for the edge (h) are now (f4) and (f5), and the boundary faces recorded for the edge (i) are now (f5) and (f6).

With reference to FIG. 19(c) and FIG. 19(d), when the tissue voxel (W) is successively replaced with a null voxel, the boundary face (f4) is removed, and a new boundary face (f7) is generated. The boundary faces recorded at the edge (e) now become (f2) and (f7), the edge (h) now only has one boundary face (f5) recorded, and the edge (j) only has the boundary face (f7) recorded. At this time, the boundary faces (f1), (f2) and (f7) are connected together by the common edges (d) and (e), while the boundary faces (f5) and (f6) are connected together by the common edge (i). Therefore, the object volume now has two groups of tissue voxels that form two separate tissue structures. In this embodiment, the determination of which tissue voxels belong to either group is conducted using a seed-and-flood algorithm.

In particular, when a tissue voxel is replaced with a null voxel, data related to every new boundary face is stored in a first hash table, and then an iterative process is implemented. The stored data includes a face type and a position of the corresponding boundary face. The face type is one of first, second and third types, indicating the corresponding boundary face has a fixed coordinate component in a corresponding one of the first, second and third axes (X_{object}, Y_{object}, Z_{object}). The position represents the fixed coordinate component in the corresponding axes (X_{object}, Y_{object}, Z_{object}) for the corresponding boundary face.

First, one boundary face is taken out of the first hash table to be stored in a second hash table as a processing basis. The remaining boundary faces in the first hash table are checked to see if they share any of the four edges of the basic boundary face with the basic boundary face. If there is at least one edge-sharing boundary face in the first hash table, said at least one edge-sharing boundary face is also taken out of the first hash table to be stored in the second hash table, and the process iterates with said at least one edge-sharing boundary face serving as the basic boundary face. The iteration is completed wgeb the first hash table is empty or until no edge-sharing boundary faces can be found for serving as the basic boundary face. In the case where the iteration ends with the first hash table empty, there is only one tissue structure. Otherwise, there are at least two separate tissue structures, with the first and second hash tables respectively recording the boundary faces of the tissue structures. In the case where there are two tissue structures, the seed-and-flood algorithm is used to determine which tissue voxels belong to which one of the groups that respectively constitute separate tissue structures.

Referring to the 2 D simplified example of FIGS. 19(a) to 19(d), when the first nullified voxel (U) (i.e., the first tissue voxel that is replaced with a null voxel) appears, the data related to the new boundary faces (f1), (f2) and (f3) are recorded in the first hash table. The face type for each of the boundary faces (f1) and (f3) is the second type, and for the boundary face (f2) is the first type. The positions for the boundary faces (f1), (f2) and (f3) are respectively determined by adding the vectors (0, 0.5), (−0.5, 0) and (0, −0.5) to the center position of the voxel (U). One of these three boundary faces (e.g., the boundary face (f1)) is taken from the first hash table to be stored in a second hash table. The edges of this boundary face are determined with reference to the face type and the position of the boundary face. For example, the position of the −X direction edge (d) is determined by adding (−0.5, 0) to the position of the boundary face (f1), and is equivalent to the position of the boundary face (f2) added by (0, 0.5). This means that the edge (d) is a Y direction edge of the boundary face (f2), and thus is shared by the boundary faces (f1) and (f2). Therefore, the boundary face (f2) is then taken out of the first hash table to be stored in the second hash table. Similar to the above determination, it is found that the boundary face (f3) shares an edge (e) with the boundary face (f2), and is therefore taken out of the first hash table. At this time, the first hash table is empty. It is thus concluded that the object volume does not contain two separate tissue structures when the tissue voxel (U) is nullified (or replaced with a null voxel).

To iterate the process, the second hash table now becomes the first hash table for a subsequent separation check. When the tissue voxel (V) is nullified successively, the boundary face (f3) is deleted and removed from the new first hash table. New boundary faces (f4), (f5) and (f6) are generated and are recorded in the new first hash table. Then, the iteration begins. After the iteration process is completed, it is found that each of edges (d), (e), (i) and (h) is common to at least two of the boundary faces (f1), (f2), (f4), (f5) and (f6) stored in the new first hash table, and therefore, the new first hash table is emptied and a new second hash table stores the boundary faces (f1), (f2), (f4), (f5) and (f6).

When the tissue voxel (W) is nullified successively, the boundary face (f4) is deleted and a new boundary face (f7) is generated. As such, the current first hash table stores the boundary faces (f1), (f2), (f5), (f6) and (f7). No matter which boundary face is used to begin the iteration process, the first hash table for the current iteration process will never be emptied, indicating that there are at least two separate tissue structures in the object volume (with the boundary faces (f1), (f2) and (f7) connected as a group, and the boundary faces (f5) and (f6) connected as another group).

Finally, the seed-and-flood algorithm is used to determine which tissue voxels belong to which one of the groups that respectively constitute separate tissue structures with a tissue voxel that shares any one of the boundary faces in one of the first and second hash tables assigned as a seed voxel (e.g., tissue voxel (S1) or (S2)).

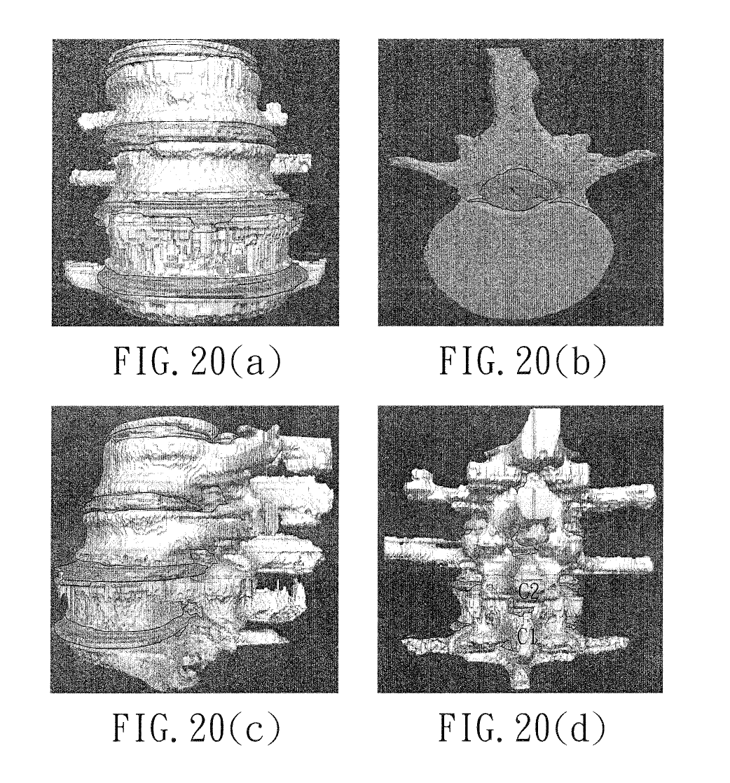

As shown in FIGS. 20(a) to 20(d), an exemplary application of the method for generating the real-time haptic response information according to the present invention is performed on a spinal surgery simulation. The purpose of the surgery simulation is to treat spinal stenosis at L3-4 and L4-5. The L4 spinal process (as indicated by (C1) in FIG. 20(d)) is to be repositioned backward to enlarge the spinal canal and the inferior L3 spinal process (as indicated by (C2) in FIG. 20(d)) is to be cut out for depression.

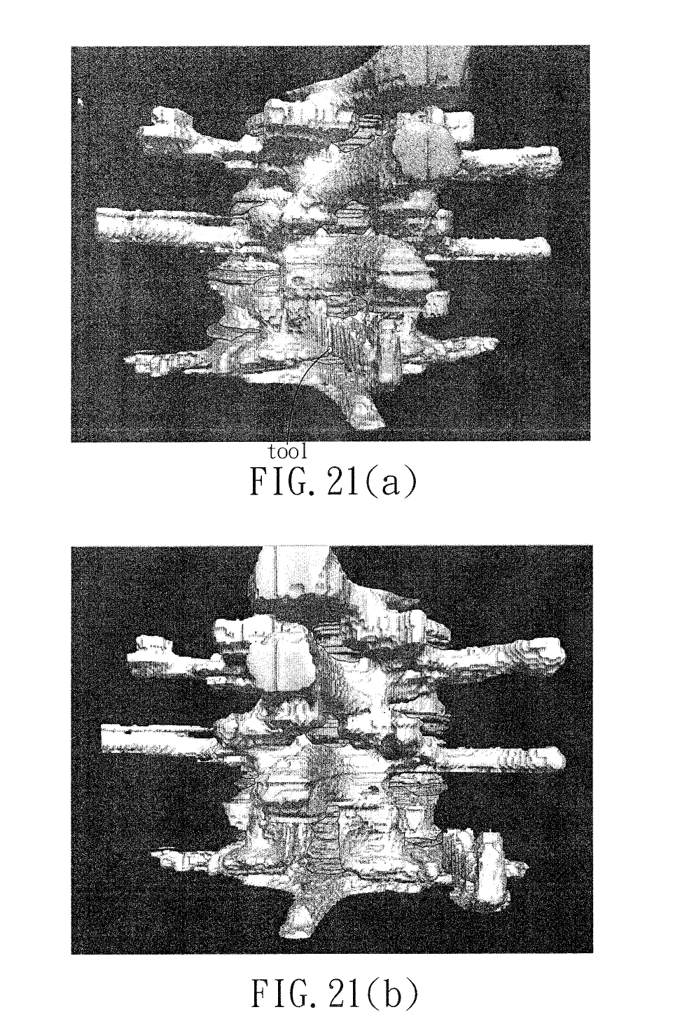

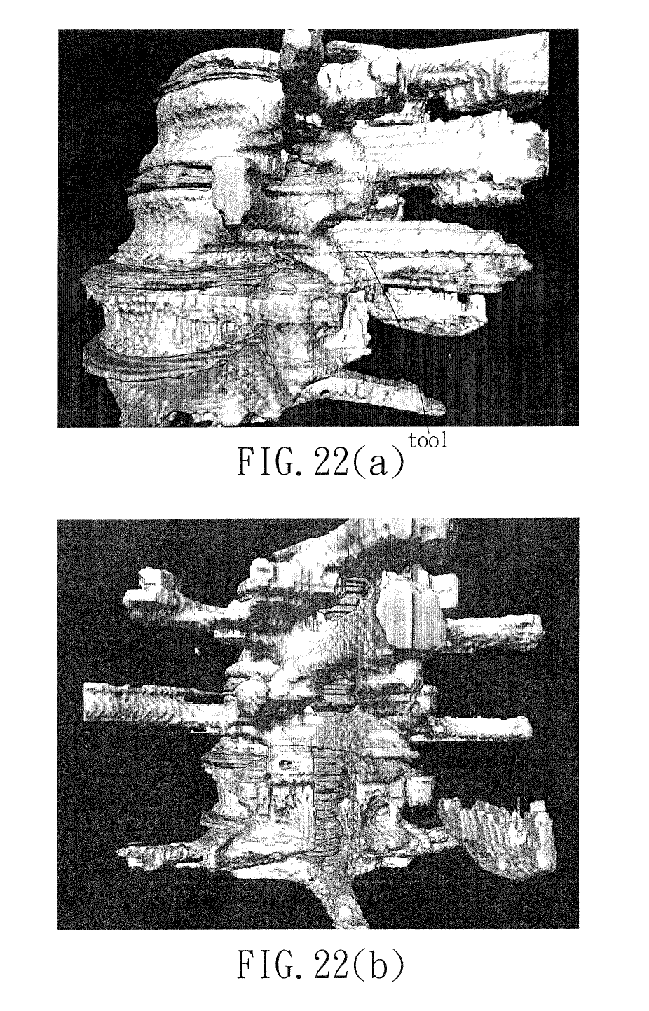

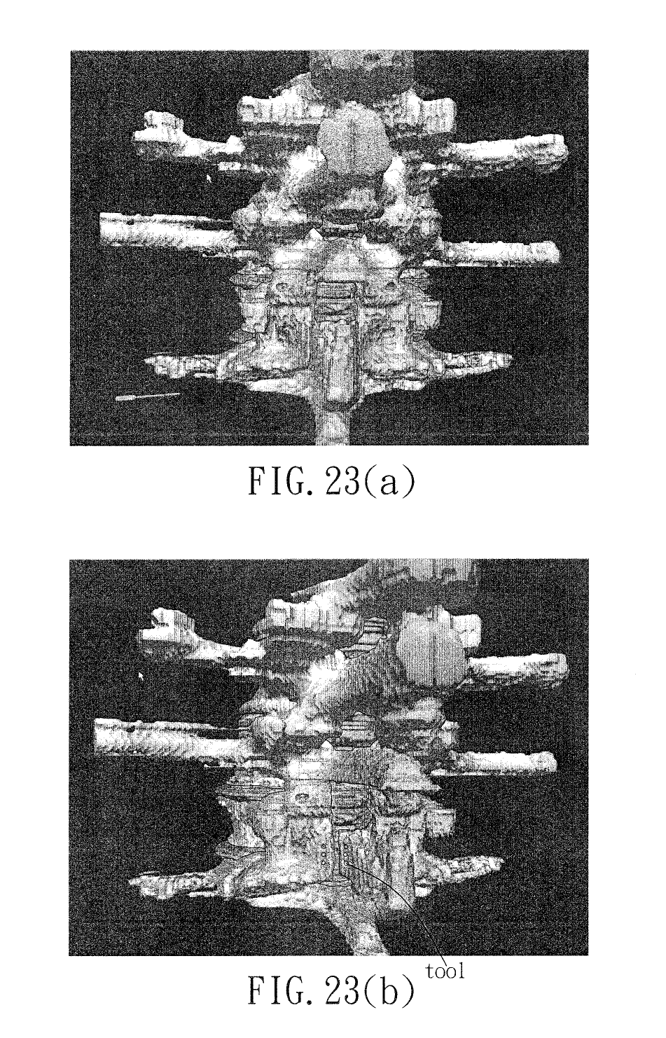

This surgery simulation includes the following steps: cutting the L4 spinal process (C1) by using a straight router with a diameter of 2 mm and a length of 12 mm (as shown in FIG. 21(a)), moving the L4 spinal process (C1) (as shown in FIG. 21(b)), cutting the inferior L3 spinal process (as shown in FIG. 22(a)), removing the cut portions of the inferior L3 spinal process (C2) (as shown in FIG. 22(b)), repositioning the L4 spinal process (C1) suitably (as shown in FIG. 23(a)), drilling six holes in the laminar and six holes in the L4 spinal process (C1) using a straight router with a diameter of 2 mm and a length of 8 mm (as shown in FIG. 23(b)), and fixing the L4 spinal process (C1) to the laminar by wiring through the holes thus drilled.

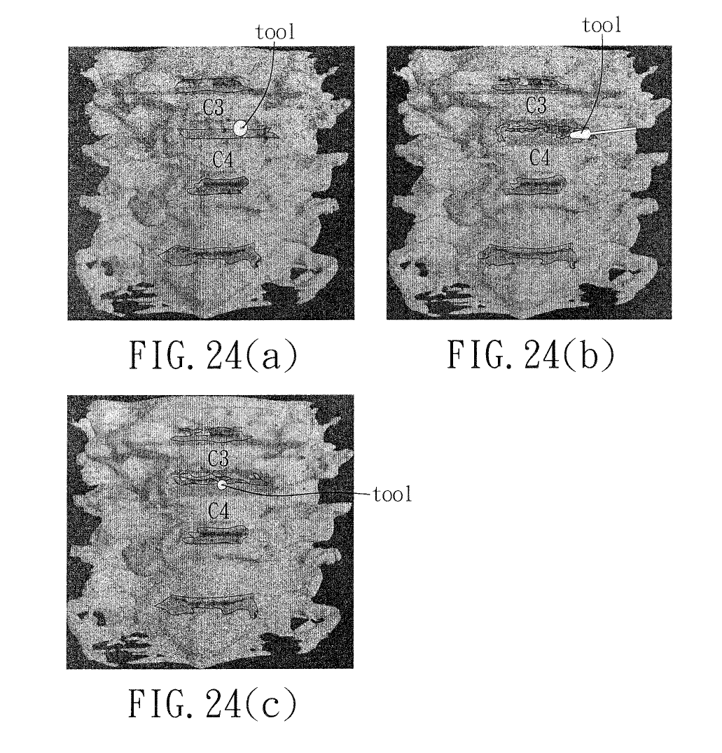

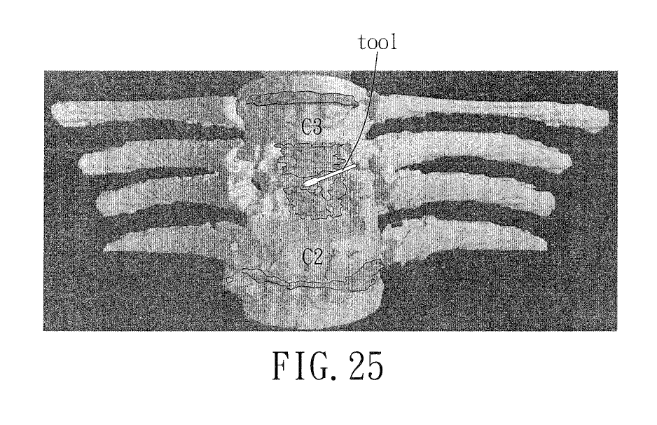

Another exemplary application of the method is shown in FIGS. 24(a) to 24(c), and is performed on a hip joint surgery. The patient suffers from pain in the right hip joint, along with numbness in the lower limb. The purpose of this surgery simulation is to remove the damaged portion of the intervertebral disk and replace it with an artificial intervertebral disk.

This surgery simulation includes the following steps: burring the cervical vertebra (C3, C4) using a burr with a diameter of 5 mm (as shown in FIG. 24(a)), burring the tissues (i.e., tumor) on two sides of the cervical vertebra (C3, C4) using a frusto-conical tool (as shown in FIG. 24(c)), and then installing an artificial intervertebral disk.

Another exemplary application of the method is shown in FIG. 25, where the patient suffers from spinal discomfort. First, the tumor has was recognized and removed. Then, two different spherical burrs respectively with diameters of 5 mm and 3 mm were used to grind the bones (C3, C4). Next, an Acorn tool was used for fine grinding. Finally, an artificial bone is installed.

In summary, the method for generating real-time haptic response information for a haptic simulating device can be employed in the medical field for training or rehearsing purposes in order for doctors to get acquainted with the reaction forces that would be encountered during surgical operations so as to enhance stability during actual surgical operations. The advantages of the present invention include:

1. Surgery simulations can be conducted using virtual tools of various virtual tool types, including the cylindrical type, the frusto-conical type, the conical type, the ellipsoidal type (as well as the spherical type), the paraboloid type, and combinations thereof.

2. The computations involved in the generation of the haptic response information are simplified, and thus require relatively less time as compared to the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating real-time haptic response information for a haptic simulating device during a surgery simulation performed on an object volume by a virtual tool that is associated with the haptic simulating device, the object volume being defined in a three-dimensional object coordinate system, and including a plurality of uniformly-spaced-apart voxels, each of the voxels being labeled as one of a tissue voxel and a null voxel, and having a voxel center position expressed by integer coordinate components in the object coordinate system, the object volume further including a plurality of object boundary points, each of which is located between a corresponding adjacent pair of the tissue and null voxels, the method comprising the steps of:
(a) receiving a select input corresponding to a selected type of the virtual tool, the selected type being selected from a group consisting of a cylindrical type, a frusto-conical type, a conical type, a spherical type, an ellipsoidal type, a paraboloid type, and combinations thereof;
(b) obtaining a plurality of tool boundary points of the virtual tool based on the selected type of the virtual tool;
(c) obtaining a current reference position of the virtual tool in the object coordinate system, the current reference position being temporally spaced apart from a previously obtained reference position of the virtual tool by a predefined haptic period;
(d) determining a current tool subvolume of the object volume in the object coordinate system based on the current reference position of the virtual tool and predefined dimensions of the virtual tool corresponding to the selected type in the object coordinate system; and
(e) upon determining that the current tool subvolume has at least one of the tissue voxels, performing the sub-steps of
(e-1) determining positions of the tool boundary points within the current tool subvolume based on the current reference position of the virtual tool and the predefined dimensions of the virtual tool,
(e-2) updating labels of the voxels within the current tool subvolume and replacing an original set of the object boundary points within the current tool subvolume with a new set of the object boundary points with reference to the positions of the tool boundary points determined in sub-step (e-1), and the voxel center positions of at least one of the tissue and null voxels within the current tool subvolume,
(e-3) determining force-contributing ones of the tool boundary points with reference to a feed direction from the previously obtained reference position of the virtual tool to the current reference position of the virtual tool, and
(e-4) providing force information of a force to be generated by the haptic simulating device according to the feed direction, a feed distance between the current and previously obtained reference positions of the virtual tool, the predefined dimensions of the virtual tool corresponding to the selected type of the virtual tool, a relationship between the positions of the force-contributing ones of the tool boundary points and the voxels within the current tool subvolume, and a predefined force parameter set.

2. The method as claimed in claim 1, the object coordinate system being defined by first, second and third axes that are orthogonal to each other, wherein in sub-step (e-1), the position of each of the tool boundary points is determined by locating a corresponding intersection between an outer surface of the virtual tool that is determined from the current reference position of the virtual tool and the predefined dimensions of the virtual tool corresponding to the selected type, and a corresponding line that is parallel to one of the first, second and third axes, and that has integer coordinate components in the other two of the first, second and third axes.

3. The method as claimed in claim 2, wherein, when the selected type of the virtual tool is the frusto-conical type, the predefined dimensions of the virtual tool corresponding to the frusto-conical type include a height of (h), a first radius of (r1) for a top surface of the frusto-cone, and a second radius of (r2) for a bottom surface of the frusto-cone;
the intersections being located in sub-step (e-1) by substituting
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {x}^{2} + {y}^{2} = {[ r 2 + z ( \frac{r 1 - r 2}{h} ) ]}^{2}$$
so as to obtain
$$t = \frac{- B \pm \sqrt{{B}^{2} - AC}}{A} , where {x}^{2} + {y}^{2} = {[ r 2 + z ( \frac{r 1 - r 2}{h} ) ]}^{2}$$
represents a surface quadratic equation of the virtual tool of the frusto-conical type in a tool coordinate system, 0≦z≦h, and
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
represents the line that is parallel to one of the first, second and third axes of the object coordinate system expressed in the tool coordinate system, and where A=(v′ₓ²+v′_{y}²−a²), B=(v′ₓp′ₓ+v′_{y}p′ₓ−ab), C=(p′ₓ²+p′ₛ²−b²),
$$a = ( \frac{r 1 - r 2}{h} ) {v}_{z}^{′} , and b = r 2 + ( \frac{r 1 - r 2}{h} ) {p}_{z}^{′} ,$$
and followed by substituting
$$t = \frac{- B \pm \sqrt{{B}^{2} - AC}}{A}$$
back into
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
to obtain coordinates of the intersections in the tool coordinate system when the condition of 0≦z≦h is satisfied.

4. The method as claimed in claim 2, wherein, when the selected type of the virtual tool is the frusto-conical type, the predefined dimensions of the virtual tool corresponding to the frusto-conical type include a height of (h), a first radius of (r1) for a top surface of the frusto-cone, and a second radius of (r2) for a bottom surface of the frusto-cone;
wherein the intersection between the outer surface of the virtual tool of the frusto-conical type other than the top and bottom surfaces and the line that is parallel to one of the first, second and third axes of the object coordinate system is located in sub-step (e-1) by substituting
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {x}^{2} + {y}^{2} = {[ r 2 + z ( \frac{r 1 - r 2}{h} ) ]}^{2}$$
so as to obtain an expression of t in terms of v′ₓ, v′_{y}, v′_{z}, p′ₓ, p′_{y}, p′_{z}, r1, r2 and h, followed by substituting the expression of t into
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
so as to obtain x, y and z coordinates of the intersection in a tool coordinate system when the condition of 0<z<h is satisfied, where
$${x}^{2} + {y}^{2} = {[ r 2 + z ( \frac{r 1 - r 2}{h} ) ]}^{2}$$
represents a surface quadratic equation of the virtual tool of the frusto-conical type in the tool coordinate system, 0≦z≦h, and
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
represents the line that is parallel to one of the first, second and third axes of the object coordinate system expressed in the tool coordinate system;
wherein the intersection between the bottom surface of the virtual tool of the frusto-conical type and the line that is parallel to one of the first, second and third axes of the object coordinate system is located in sub-step (e-1) by substituting z=0 into z=v′_{z}t+p′_{z} to obtain an expression of t in terms of v′_{z} and p′_{z}, followed by substituting the expression of t into x=v′ₓt+p′ₓ and y=y′_{y}+t+p′_{y} to obtain x and y coordinates of the intersection in the tool coordinate system when the condition of x²+y²≦r2² is satisfied; and
wherein the intersection between the top surface of the virtual tool of the frusto-conical type and the line that is parallel to one of the first, second and third axes of the object coordinate system is located in sub-step (e-1) by substituting z=h into z=v′_{z}t+p′_{z} to obtain an expression of t in terms of v′_{z} and p′_{z}, followed by substituting the expression of t into x=v′ₓt+p′ₓ and y=v′_{y}t+p′_{y} to obtain x and y coordinates of the intersection in the tool coordinate system when the condition of x²+y²≦r1² is satisfied.

5. The method as claimed in claim 2, wherein, when the selected type of the virtual tool is the ellipsoidal type, the predefined dimensions of the virtual tool corresponding to the ellipsoidal type include a first radius of (ra) and a second radius of (rz);
the intersections being located in sub-step (e-1) by substituting
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {( \frac{x}{ra} )}^{2} + {( \frac{y}{ra} )}^{2} + {( \frac{z}{rz} )}^{2} = 1$$
so as to obtain
$$t = \frac{- B \pm \sqrt{{B}^{2} - AC}}{A} , where {( \frac{x}{ra} )}^{2} + {( \frac{y}{ra} )}^{2} + {( \frac{z}{rz} )}^{2} = 1$$
represents a surface quadratic equation of the virtual tool of the ellipsoidal type in a tool coordinate system, and
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
represents the line that is parallel to one of the first, second and third axes of the object coordinate system expressed in the tool coordinate system, and where A=(a²+b²+c²), B=(ai+bj−ck), C=(i²+j²+k²−1),
$$a = \frac{{v}_{x}^{′}}{ra} , b = \frac{{v}_{y}^{′}}{ra} , c = \frac{{v}_{z}^{′}}{rz} , i = \frac{{p}_{x}^{′}}{ra} , j = \frac{{p}_{y}^{′}}{ra} , and k = \frac{{p}_{z}^{′}}{rz} ,$$
followed by substituting
$$t = \frac{- B \pm \sqrt{{B}^{2} - AC}}{A}$$
back into
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
to obtain x, y and z coordinates of the intersection in the tool coordinate system when the condition of −rz<z<rz is satisfied.

6. The method as claimed in claim 2, wherein, when the selected type of the virtual tool is the paraboloid type, the predefined dimensions of the virtual tool corresponding to the paraboloid type include a radius of (r), and a height of (h);
the intersections being located in sub-step (e-1) by substituting
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix} into {( \frac{x}{r} )}^{2} + {( \frac{y}{r} )}^{2} = z$$
so as to obtain
$$t = \frac{- B \pm \sqrt{{B}^{2} - AC}}{A} , where {( \frac{x}{r} )}^{2} + {( \frac{y}{r} )}^{2} = z$$
represents a surface quadratic equation of the virtual tool of the paraboloid type in a tool coordinate system, and
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
represents the line that is parallel to one of the first, second and third axes of the object coordinate system expressed in the tool coordinate system, and where A=(v′ₓ²+v′_{y}²,
$$B = ( {v}_{x}^{′} {p}_{x}^{′} + {v}_{y}^{′} {p}_{y}^{′} - \frac{{r}^{2}}{2} {v}_{z}^{′} ) ,$$
and C=(p′ₓ²+p′_{y}²+r²p′_{z}), followed by substituting
$$t = \frac{- B \pm \sqrt{{B}^{2} - AC}}{A}$$
back into
$$\{ \begin{matrix}x = {v}_{x}^{′} t + {p}_{x}^{′} \\ y = {v}_{y}^{′} t + {p}_{y}^{′} \\ z = {v}_{z}^{′} t + {p}_{z}^{′}\end{matrix}$$
to obtain x, y and z coordinates of the intersection in the tool coordinate system when the condition of 0≦z≦h is satisfied.

7. The method as claimed in claim 2, wherein, when the selected type of the virtual tool is a combination of the cylindrical type and the ellipsoidal type, and is a semi-ellipsoid combined with a cylinder, the intersections are located in sub-step (e-1) by locating intersections between the outer surface of the virtual tool of the cylindrical type that has the predefined dimensions of a radius of (r1) and a height of (h) along a z-axis in a tool coordinate system, and the line that is parallel to one of the first, second and third axes of the object coordinate system for 0≦z≦h, and locating intersections between the outer surface of the virtual tool of the ellipsoidal type that has the predefined dimensions of a first radius of (r1) and a second radius of (r2), and the line that is parallel to one of the first, second and third axes of the object coordinate system for h<z<h+r2.

8. The method as claimed in claim 1, wherein the object coordinate system is defined by first, second and third axes that are orthogonal to each other, the object volume being generated based on a volume database that contains a plurality of voxel data sets, each of which represents a corresponding one of the voxels in the object volume, and contains a first-axis coordinate component, a second-axis coordinate component, a third-axis coordinate component, and a voxel label, the first, second and third-axis coordinate components cooperating to indicate the voxel center position of the corresponding one of the voxels, the voxel label indicating the corresponding one of the voxels to be one of the tissue and null voxels, the voxel data set corresponding to one of the voxels in an adjacent pair of the tissue and null voxels further containing a face flag, the face flag indicating that the adjacent pair of the tissue and null voxels shares a boundary face in a corresponding one of six directions along the first, second and third axes.

9. The method as claimed in claim 8, wherein sub-step (e-2) further includes updating the voxel data sets of the voxels within the current tool subvolume with reference to the positions of the tool boundary points determined in sub-step (e-1), and the voxel center positions of at least one of the tissue and null voxels within the current tool subvolume; and
wherein, when at least one boundary face cannot be connected to the other boundary faces, it is determined that the object volume contains at least two separate groups of tissue voxels that form two separate tissue structures with reference to the face flags of the updated voxel data sets.

10. The method as claimed in claim 9, wherein when it is determined that the object volume contains at least two separate groups of tissue voxels, a seed-and-flood algorithm is used to determine which tissue voxels in the object volume belong to which group.
